(19) United States
(12) Patent Application Publication
(10) Pub. No.: US 2014/0229284 A1
(43) Pub. Date: Aug. 14, 2014

(54) ELECTRONIC MAP

(71) Applicant: INTERNATIONAL BUSINESS MACHINES CORPORATION, (US)

(72) Inventors: Lisa Seacat DeLuca, San Francisco, CA (US); Lydia M. Do, Research Triangle Park, NC (US); Charles Marcel Kinard, Research Triangle Park, NC (US)

(73) Assignee: INTERNATIONAL BUSINESS MACHINES CORPORATION, Armonk, NY (US)

(21) Appl. No.: 13/767,381

(22) Filed: Feb. 14, 2013

(51) Int. Cl. G06Q 30/02

(52) U.S. Cl. CPC G06Q 30/0259
USPC 705/14.57

(57) ABSTRACT

A method includes, determining a zoom level for a selected portion of an electronic map, harvesting map data from the selected section the electronic map, determining building information from the harvested map data, obtaining branding information for the building information, and a user device receiving and populating said zoomed section of the electronic map with the branding information.

### BACKGROUND

The present invention relates to electronic maps, and more specifically, to provide branding and advertisements for electronic maps.

### SUMMARY

According to one aspect of the present invention, a method includes, determining a zoom level for a selected portion of an electronic map, harvesting map data from the selected section the electronic map, determining building information from the harvested map data, obtaining branding information for the building information, and a user device receiving and populating said zoomed section of the electronic map with the branding information.

According to another aspect of the present invention, a computer system includes, one or more processors, one or more computer-readable memories and one or more computer-readable, tangible storage devices; a location determining module operatively coupled to at least one of the one or more storage devices for execution by at least one of the one or more processors via at least one of the one or more memories, configured to determine the location of an user on an electronic map, a map interaction engine operatively coupled to at least one of the one or more storage devices for execution by at least one of the one or more processors via at least one of the one or more memories, configured to zoom a selected selection of the electronic map, a selection module operatively coupled to at least one of the one or more storage devices for execution by at least one of the one or more processors via at least one of the one or more memories, configured to harvest map data from the selected section of the electronic map, a building directory module operatively coupled to at least one of the one or more storage devices for execution by at least one of the one or more processors via at least one of the one or more memories, configured to determine building information from the harvested map data, a branding engine operatively coupled to at least one of the one or more storage devices for execution by at least one of the one or more processors via at least one of the one or more memories, configured to obtain branding information for the building information within the zoomed section of the electronic map, and a population module operatively coupled to at least one of the one or more storage devices for execution by at least one of the one or more processors via at least one of the one or more memories, populating the zoomed section of the electronic map with the branding information around the location of the user.

According to still another aspect of the present invention, a computer program product includes, one or more computer-readable, tangible storage medium; program instructions, stored on at least one of the one or more storage medium, to determine the location of a mobile user on an electronic map, program instructions, stored on at least one of the one or more storage medium, to zoom a selected selection of the electronic map, program instructions, stored on at least one of the one or more storage medium, to harvest map data from the selected section of the electronic map, program instructions, stored on at least one of the one or more storage medium, to determine building information from the harvested map data, program instructions, stored on at least one of the one or more storage medium, to obtain branding information for the building information within the zoomed section of the electronic map, and program instructions, stored on at least one of the one or more storage medium, to populate the zoomed section of the electronic map with the branding information around the location of the mobile user.

### BRIEF DESCRIPTION OF THE SEVERAL VIEWS OF THE DRAWINGS

FIG. 1 illustrates a branding and advertisement diagram for electronic maps according to an embodiment of the present invention.

FIG. 2 depicts an electronic map according to an embodiment of the present invention.

FIG. 3 depicts an exemplary implementation according to an embodiment of the present invention.

FIG. 4 depicts another exemplary implementation according to an embodiment of the present invention.

FIG. 5 illustrates a hardware configuration according to an embodiment of the present invention.

FIGS. 6A and 6B illustrate user devices according to embodiments of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

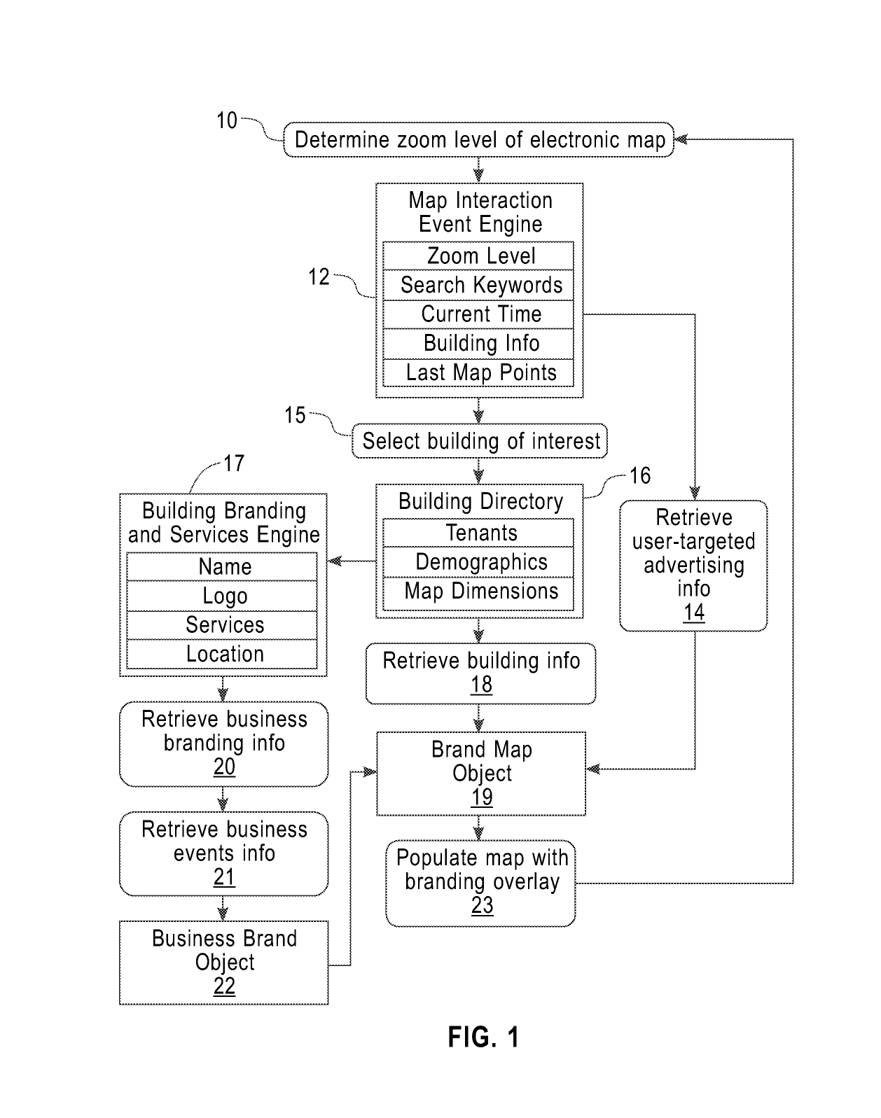

With reference now to FIG. 1, a user, using an electronic device, zooms into a section of an electronic map such that the outlines of the buildings are discernible. Once the zoom level of the electronic map is determined (10) interactive data is harvested and sent to the Map Interaction Event Engine (12). The interactive data may include but is not limited to:

zoom-level of the electronic map;

key word search of location on map;

current time of the map interaction;

building information within the map view; and

the last locations or points on the map of interest to the user.

The purpose of the Map Interaction Engine is to compile information about how a user interacts with a mapping application. This information may be harvested as a result of mining application data, application settings, device settings, user profiles, analysis performed on the application server, or by querying the user for such information.

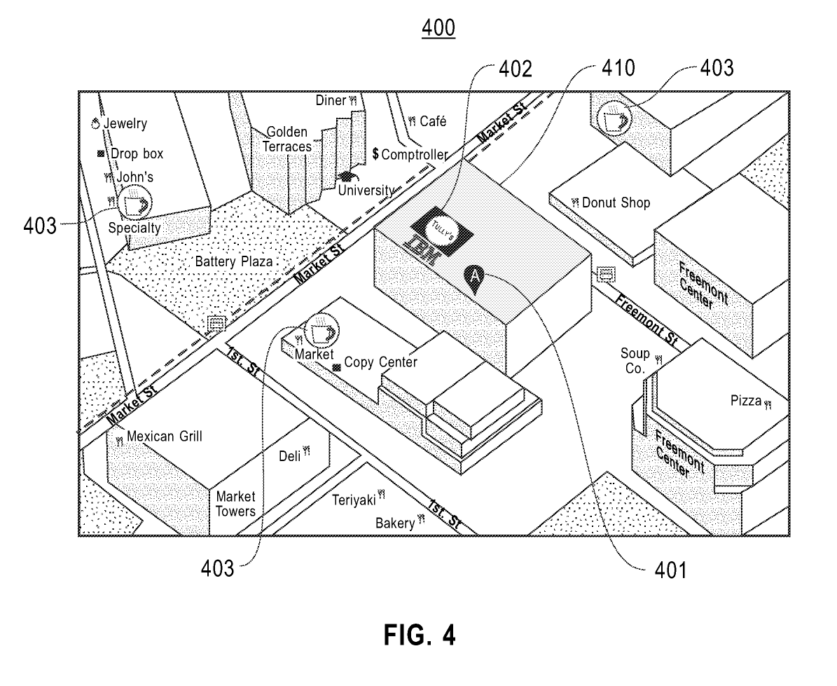

Based on the interactive data, user targeted advertising info may be determined (14). More detailed information regarding advertisements will be described in further detail with reference to FIG. 4. A building is selected in the electronic map (15). The building directory (16) module gathers the building information such as but is not limited to:

tenants (i.e. businesses, residents, etc.);

demographics; and

building/map dimensions.

The building information serves as a guide to the tenants or occupants of a building and where appropriate also may include mailing address, space layout, room capacities, a history of the property, and its namesake. When a building is occupied by several tenants, it is helpful to determine the parties involved in order to establish each parties stake in the marketing of the property for business branding and advertisement purposes.

The building directory information is passed to a Business Branding and Services Engine 17 and to a retrieval building information module 18. The Business Branding and Services Engine 17 provides the business branding information such as but is not limited to:

business name;

logo;

services provided; and

location(s).

The business branding information can also be represented as prominent colors, mascots, symbols, trademarks, street, or product associations that a business is publicly linked to. Therefore, the business branding information is any information that distinguishes one seller's good or service as distinct from those of other sellers. A retrieval business branding module 20 receives the business branding information from the Business Branding and Services Engine 17.

Still referring to FIG. 1 Business Branding and Services Engine 17 can also provide upcoming business events of interest to a business event module 21. Companies may choose to change their branding messages based on events. The event information may change as it relates to the end-user who is interacting with the mapping application. For example, a user may be searching for social events in a zoomed section of the map and events and businesses of interest may be shown in the context of those social events and according to the user's preferences.

Alternatively, a branding message may appear differently, for example, depending on the type of event, its duration, or its impact to other businesses or neighbors. For example: During IBM's big LotusSphere conference a logo on the building could rotate to indicate that the event is currently taking place. The aggregated business information from the retrieval module 20 and the business event module 21 are used to build a Business Brand Object 22. A Brand Map Object 19 is formed by collecting and combining information from the Business Brand Object 22, the retrieval building information module 18 and the user-targeted advertising information 14. Once the Brand Map Object 19 is built a populate module 23 populates the zoomed electronic map with the branding information.

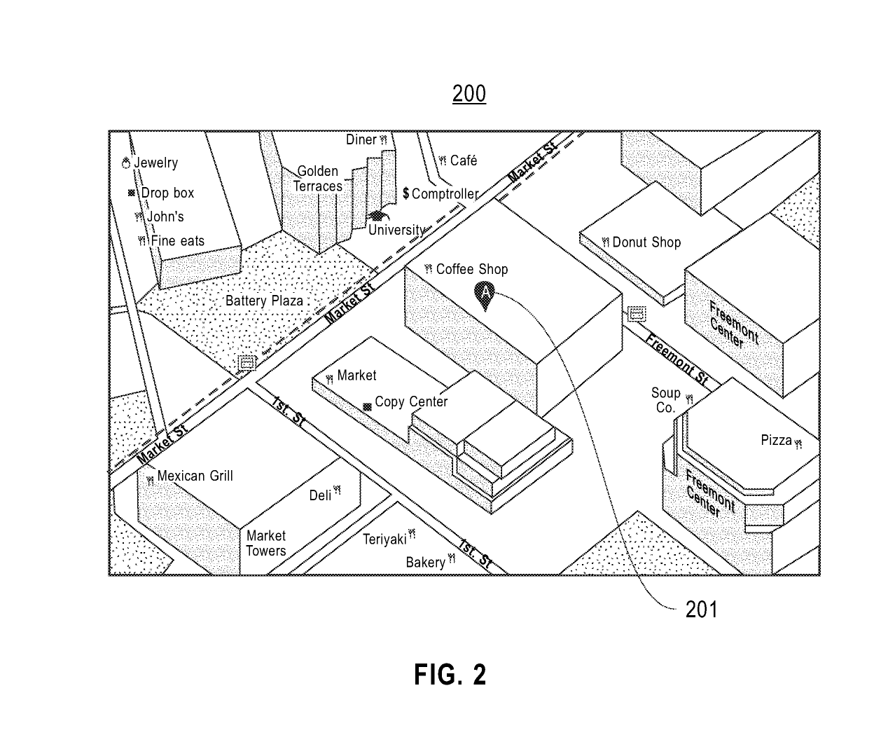

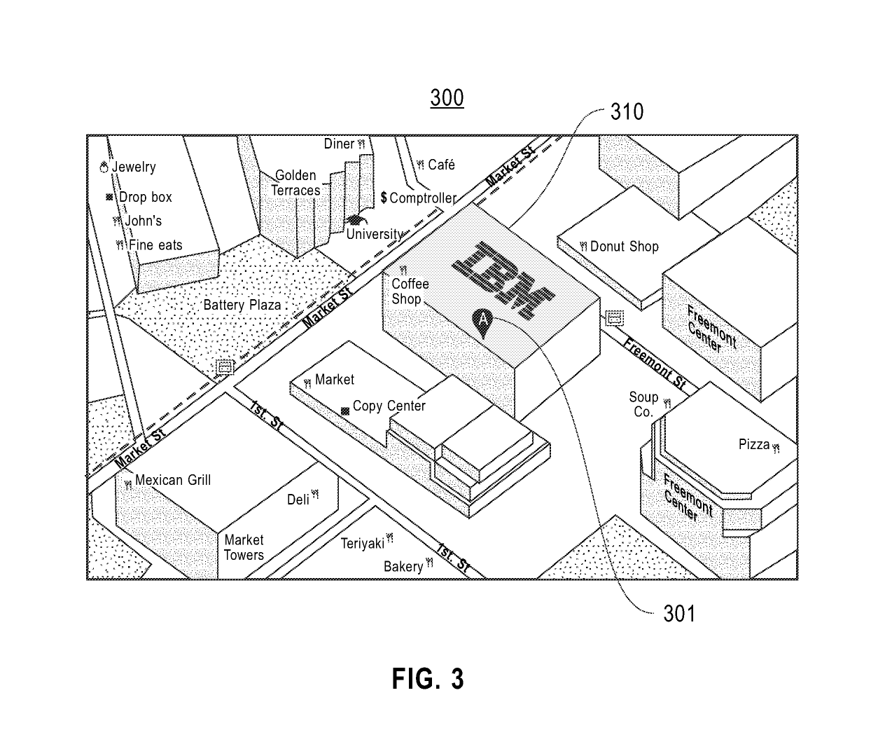

Referring to FIGS. 2 and 3, zoomed sections of an electronic map (200, 300) are depicted. The zoomed sections further include the location (201, 301) of a point of interest to the user. This may include a current location for the user or a searched for location that the user is interested in. The Brand Map Object 19 from FIG. 1 is used to populate the map with the branding overlay 310. The branding displayed could be interactive. For example: a simple link to more information about the business triggered by a click, a window or app triggered by a mouse-over, or interaction with an external application such as Foursquare or Yelp. Another embodiment may include branding for events that are not located in a building, such as a public cultural fair held in a street or a park.

Referring to FIG. 4, another embodiment of the present invention places advertisements based upon the user-targeted advertising information 14. The user-targeted advertising information 14 may be from search results or user added information. A zoomed electronic map 400 shows the location of a point of interest to the user 401. Surrounding the user 401 are various buildings, streets and parks. The point of interest to the user 401 is located within a building that has two electronic overlays. One overlay is a brand overlay 410. The other overlay that includes an advertisement overlay 402. Further shown are additional advertisements overlays 403. According to yet embodiment of the present invention could place additional electronic advertisement overlays that would appear on top of the street or park in the map (i.e. area of the map), instead of the building.

If a user moves to a new zoom level or section of the map, the above process repeats. The user's location need not be shown in the new view. However, tenants and advertising information can still be populated on the new zoomed view of the electronic map. When there is a rotating tenant, there includes the possibility of showing multiple different advertisements for a particular location. The decision about which advertisement that could be shown to the user may again be based upon:
time of day that the map is viewed (for example, 24-hour stores could get preference when viewed late at night when other stores are closed);
the geographical location of the user (for example, tourist destinations could get preference when the viewer is far away);
attributes of the population of the user's geographical location (for example, education and income level);
search history of the user (for example, previous searches for the word “coffee”);
or
other known attributes of the user (for example, signed in with a user profile that indicates they like eco-friendly businesses or romance movies).

If a particular web site links to a map via some kind of referral, the advertisement decision could be based on the referral, such as specifically choosing an advertisement to match the referral. For instance, referrals from a movie could highlight the movie's advertisement at the theatre, or referrals from the car magazine. Additionally, ad placement costs may vary: for example a business may get charged more to guarantee getting their ad selected when a certain criteria is met using the attributes listed previously (the business is targeting a specific clientele).

As mentioned with reference to FIG. 4, multiple advertisements can be overlaid on the zoomed electronic map. There exist a few options to get them displayed on the electronic map view including:
stack advertisements—rotate between the advertisements;
rotation between ads could happen at fixed intervals; or
rotation between ads could vary according to the cost, bid level or user characteristics.

The branding and advertisements can have various styling preferences/attributes. They include but are not limited to setting:
Size—The size or animation of the branding might change based on how much a company is willing to spend on the advertisements; and
Opacity—The opacity of the branding might change based on how much a company is willing to spend on the advertisements.
Scale—The scale of the branding may be more pronounced as to take up more area or space than other business names, logos, or advertisements.

Aspects of the present invention are preformed in back end systems or servers and pushes the branding and advertisements information to the user's electronic device. Other aspects of the invention may take advantage of applications residing on the user's electronic device to populate the device with the branding and advertisements.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

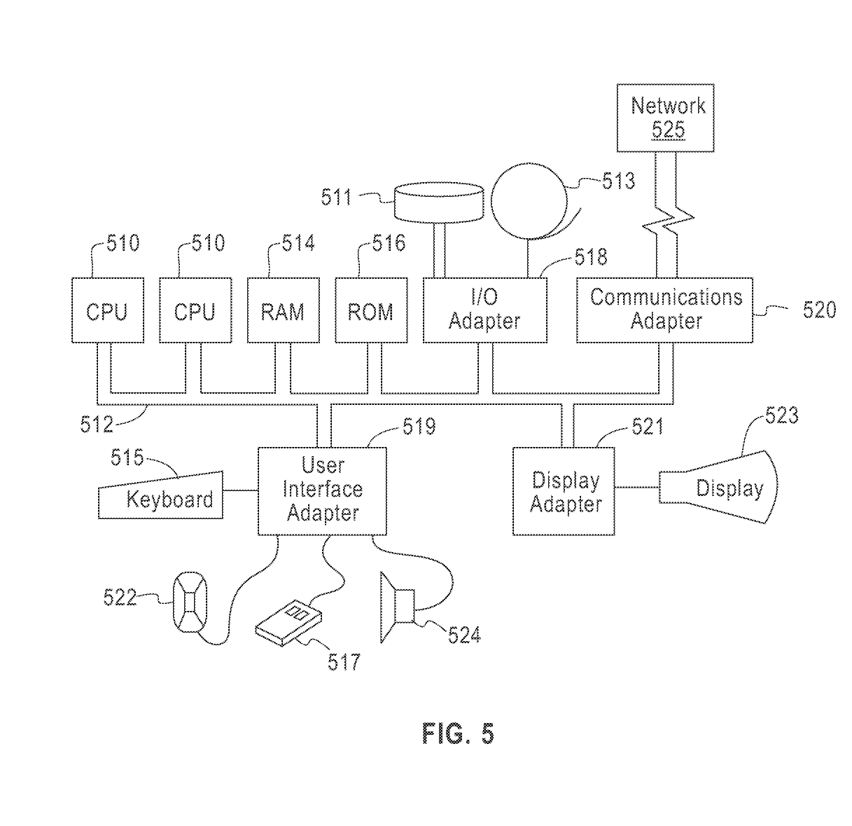

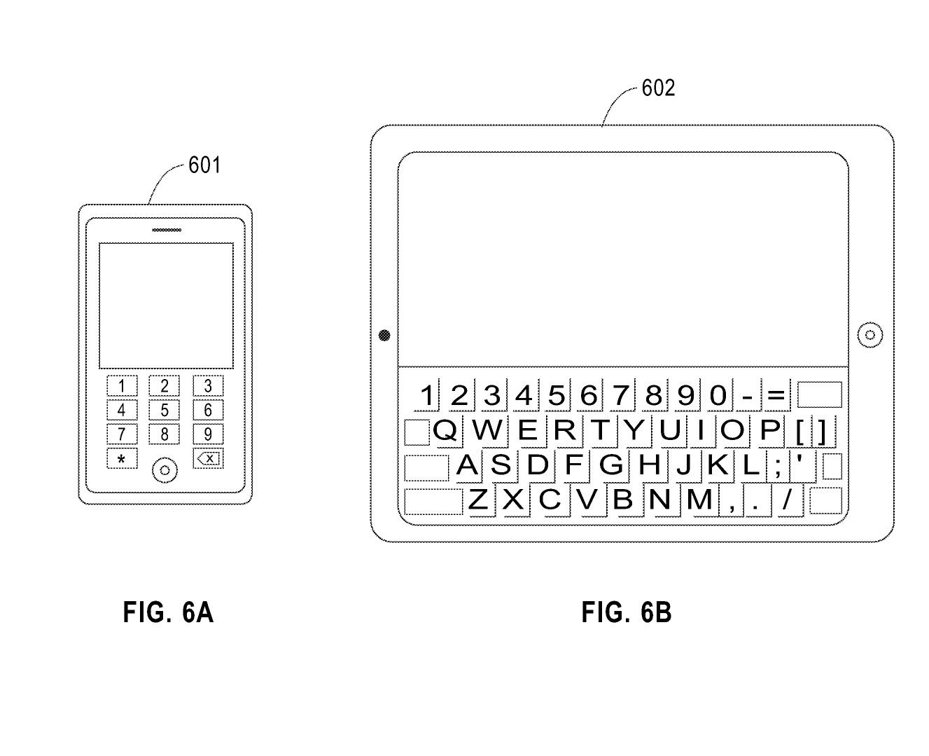

Referring now to FIGS. 5 and 6, this schematic drawing illustrates a hardware configuration of an information handling/computer system in accordance with the embodiments of the invention. The system comprises at least one processor or central processing unit (CPU) 510. The CPUs 510 are interconnected via system bus 512 to various devices such as a random access memory (RAM) 514, read-only memory (ROM) 516, and an input/output (I/O) adapter 518. The I/O adapter 518 can connect to peripheral devices, such as disk units 511 and tape drives 513, or other program storage devices that are readable by the system. The system can read the inventive instructions on the program storage devices and follow these instructions to execute the methodology of the embodiments of the invention. The system further includes a user interface adapter 519 that connects a keyboard 515, mouse 517, speaker 524, microphone 522, and/or other user interface devices such as a touch screen device (not shown) to the bus 512 to gather user input. Additionally, a communication adapter 520 connects the bus 512 to a data processing network 525, and a display adapter 521 connects the bus 512 to a display device 523 which may be embodied as an output device such as a monitor, printer, or transmitter, for example. User electronic devices (601 and 602) receives the branding and advertisements information via the data processing network 525. The processing network 525 can be either a wired or wireless network. According embodiments of the present invention user electronic device 601 may be a smart phone. While user electronic device 602 may be either a tablet or slate like computer.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
determining a zoom level for a selected portion of an electronic map,
harvesting map data from the selected section the electronic map,
determining building information from the harvested map data,
obtaining branding information for the building information, and
a user device receiving and populating said zoomed section of the electronic map with the branding information.

2. The method according to claim 1, wherein said branding information changes depending on the local time of day.

3. The method according to claim 1, wherein said branding information changes depending on the viewing quantity of the zoomed section of said electronic map.

4. The method according to claim 1, wherein said branding information changes depending on an event occurring within the zoomed section of said electronic map.

5. The method according to claim 1, wherein said building information further includes determining tenant information.

6. The method according to claim 1, further comprising having advertisements on the user device within said populated zoomed section of electronic map along with said branding information.

7. The method according to claim 6, further comprising varying the size of said advertisement and branding information.

8. The method according to claim 7, wherein said advertisement size and branding information is based upon fee payments.

9. The method according to claim 6, wherein said advertisement and branding information size is based upon the geographical location of a user versus said zoomed section of said electronic map.

10. A computer system comprising:
one or more processors, one or more computer-readable memories and one or more computer-readable, tangible storage devices;
a location determining module operatively coupled to at least one of the one or more storage devices for execution by at least one of the one or more processors via at least one of the one or more memories, configured to determine the location of an user on an electronic map,
a map interaction engine operatively coupled to at least one of the one or more storage devices for execution by at least one of the one or more processors via at least one of the one or more memories, configured to zoom a selected selection of said electronic map,
a selection module operatively coupled to at least one of the one or more storage devices for execution by at least one of the one or more processors via at least one of the one or more memories, configured to harvest map data from said selected section of said electronic map,
a building directory module operatively coupled to at least one of the one or more storage devices for execution by at least one of the one or more processors via at least one of the one or more memories, configured to determine building information from said harvested map data,
a branding engine operatively coupled to at least one of the one or more storage devices for execution by at least one of the one or more processors via at least one of the one or more memories, configured to obtain branding information for said building information within said zoomed section of said electronic map, and
a population module operatively coupled to at least one of the one or more storage devices for execution by at least one of the one or more processors via at least one of the one or more memories, populating said zoomed section of said electronic map with said branding information around said location of said user.

11. The system according to claim 10, wherein said branding information changes depending on the local time of day.

12. The system according to claim 10, wherein said branding information changes depending on how many times the zoomed section of said electronic map has been viewed.

13. The system according to claim 10, wherein said building information further includes determining tenant information.

14. The system according to claim 10, further includes an advertisement module operatively coupled to at least one of the one or more storage devices for execution by at least one of the one or more processors via at least one of the one or more memories, placing advertisements on said populated zoomed section of electronic map along with said branding information.

15. The system according to claim 14, wherein the sizes of said advertisements and branding information are variable.

16. The system according to claim 15, wherein said advertisement and branding information size is based upon fee payments.

17. The system according to claim 15, wherein said advertisement size is based upon the geographical location of said user.

18. A computer program product comprising:
one or more computer-readable, tangible storage medium;
program instructions, stored on at least one of the one or more storage medium, to determine the location of a mobile user on an electronic map,
program instructions, stored on at least one of the one or more storage medium, to zoom a selected selection of said electronic map,
program instructions, stored on at least one of the one or more storage medium, to harvest map data from said selected section of said electronic map,
program instructions, stored on at least one of the one or more storage medium, to determine building information from said harvested map data,
program instructions, stored on at least one of the one or more storage medium, to obtain branding information for said building information within said zoomed section of said electronic map, and
program instructions, stored on at least one of the one or more storage medium, to populate said zoomed section of said electronic map with said branding information around said location of said mobile user.

19. The computer program product according to claim 18, wherein said branding information changes depending on the local time of day.

20. The computer program product according to claim 18, wherein said branding information changes depending on how many times the zoomed section of said electronic map has been viewed.

21. The computer program product according to claim 18, wherein said building information further includes determining tenant information.

22. The computer program product according to claim 18, further includes program instructions, stored on at least one of the one or more storage medium, for placing advertisements on said populated zoomed section of electronic map along with said branding information.

23. The computer program product according to claim 22, further includes program instructions, stored on at least one of the one or more storage medium, to vary the size of said advertisement and branding information.

24. The computer program product according to claim 23, wherein said advertisement and branding information size is based upon fee payments.

25. The computer program product according to claim 23, wherein said advertisement and branding information size is based upon the geographical location of said user.
